(19) United States
(12) Patent Application Publication
(10) Pub. No.: US 2011/0229851 A1
(43) Pub. Date: Sep. 22, 2011

(54) COUPLING DEVICE AND METHOD FOR COUPLING IN AN IMPLANT SYSTEM

(75) Inventors: Marinus Robertus Tuinenburg, Etten-Leur (NL); Guido Joseph Maria Houg, Goes (NL); Klaas Houten, Goes (NL)

(73) Assignee: ACCURA HOLDING B.V., Bergen op Zoom (NL)

(21) Appl. No.: 13/003,220

(22) PCT Filed: Jul. 8, 2009
(86) PCT No.: PCT/NL09/50412

§ 371 Date: May 17, 2011

(30) Foreign Application Priority Data
Jul. 8, 2008 (NL) 2001780
Jul. 8, 2009 (NL) PCT/NL2009/050412

(51) Int. Cl. A61C 8/00

(52) U.S. Cl. 433/173

(57) ABSTRACT

A coupling device for an implant system, for coupling with a corresponding coupling part, wherein the coupling device is provided with at least one wall extending about a central axis, and at least a part of said at least one wall operatively abuts at least one corresponding wall of said corresponding coupling part so that operatively the coupling device and said coupling part are kept in position with respect to one another, wherein a first part of said at least one wall extends approximately parallel, or at a first, relatively small angle, with respect to said central axis, and a second, beveled part of said at least one wall tapers relatively much with respect to said central axis, or at least extends at a second angle with respect to said central axis which is larger than said first angle, so that upon coupling of the coupling device with said coupling part a relatively open space is provided between the second, beveled part and said corresponding coupling part.

The invention relates to a coupling device for an implant system, for coupling with a corresponding coupling part, wherein the coupling device is provided with at least one wall extending about a central axis, and at least a part of said at least one wall operatively abuts at least one corresponding wall of said corresponding coupling part so that operatively the coupling device and said coupling part are kept in position relative to one another.

The invention further relates to a method for coupling a coupling device.

It is known to couple a secondary part, such as an abutment, with an implant. The abutment then serves, for instance, as a support of a denture, while the implant needs to be fixed, in particular screwed, into the jaw of a patient. The abutment is, for instance, provided with an octagonal projection, which can be slid into an octagonal hole of an implant, wherein the external surfaces of the abutment closely abut the internal surfaces of the implant. Once coupled, mutual rotation between the abutment and the implant will be prevented in that the surfaces abut one another. As a result, the orientation or positioning of the abutment with respect to the implant is determined by the orientation of the abutment. Other suitable implant systems are, for instance, provided with triangular, quadrangular or hexagonal projections with corresponding holes. Often, multiple implants are fixed in a jaw, with an abutment construction of multiple abutments which are interconnected via a bridge, or a different construction such as a milled bar, crown or imprint, being coupled simultaneously with the implants.

In principle, upon coupling of implant and abutment, the external surfaces of the abutment need to extend parallel to the internal surfaces of the implant. The abutment is then often slid into the implant approximately parallel to a longitudinal axis or central axis of the implant. When an abutment construction with multiple abutments which are intercoupled via a bridge or a different construction needs to be coupled with multiple implants, it is important that the implants extend parallel with respect to one another, so that, also parallel to one another, the different intercoupled abutments can simultaneously be slid into the different implants and can be removed therefrom again. However, it is difficult, and therefore not always feasible, to get the implants in parallel position. In such cases, sometimes abutments are used which are not provided with a polygon, so that the orientation and/or direction of fitting of the abutments can be adjusted. However, then the stability of the system, i.e. the individual orientation and adequate blocking of rotation, is often lost. In addition, the assembly of implants with abutment construction is then often less solid.

It is therefore an object of the invention to offer an alternative to existing coupling systems, in particular existing implant systems.

This object and/or other objects can be achieved with a coupling device according to claim 1.

This object and/or other objects can also be achieved with a method according to claim 14.

Further effects and measures of the present invention follow from the following description, in which the invention will described in more detail in multiple exemplary embodiments with reference to the appended drawings, in which:

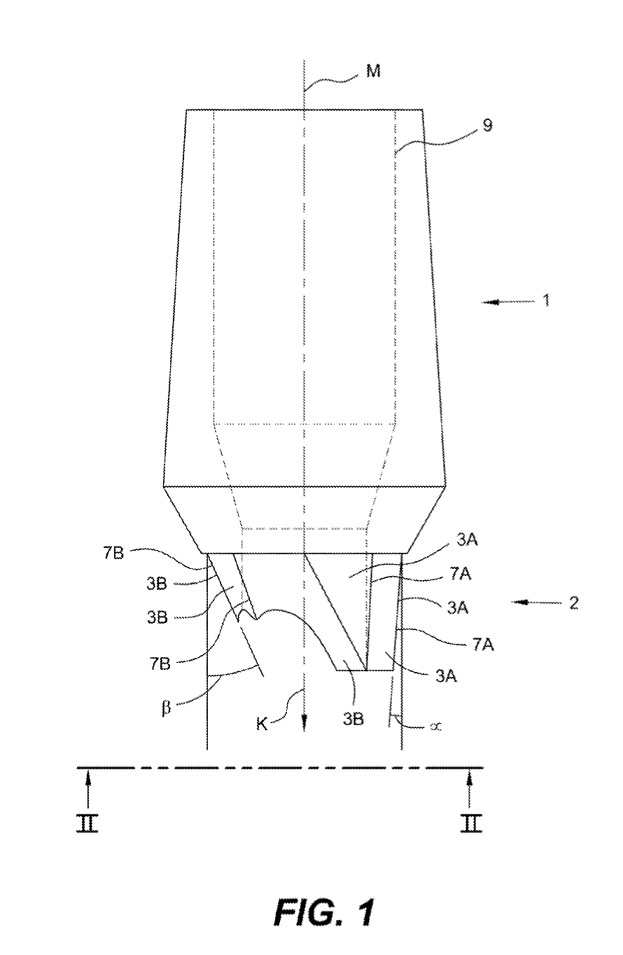

FIG. 1 shows a front view of an abutment;

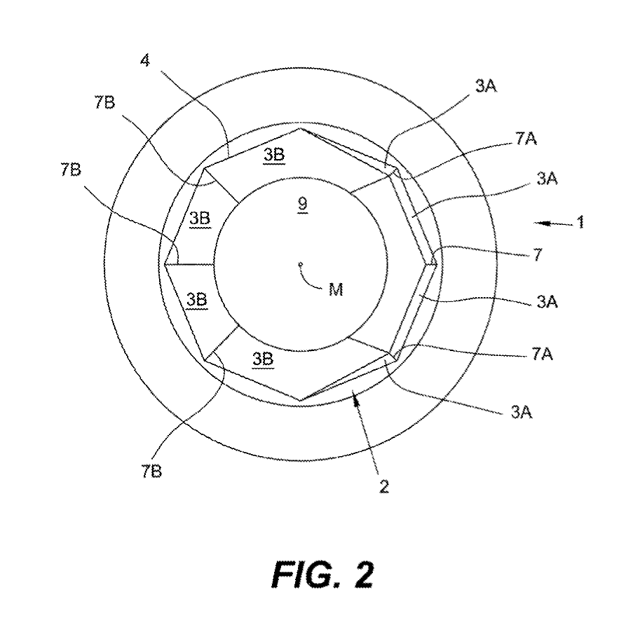

FIG. 2 shows a bottom view of an abutment of FIG. 1;

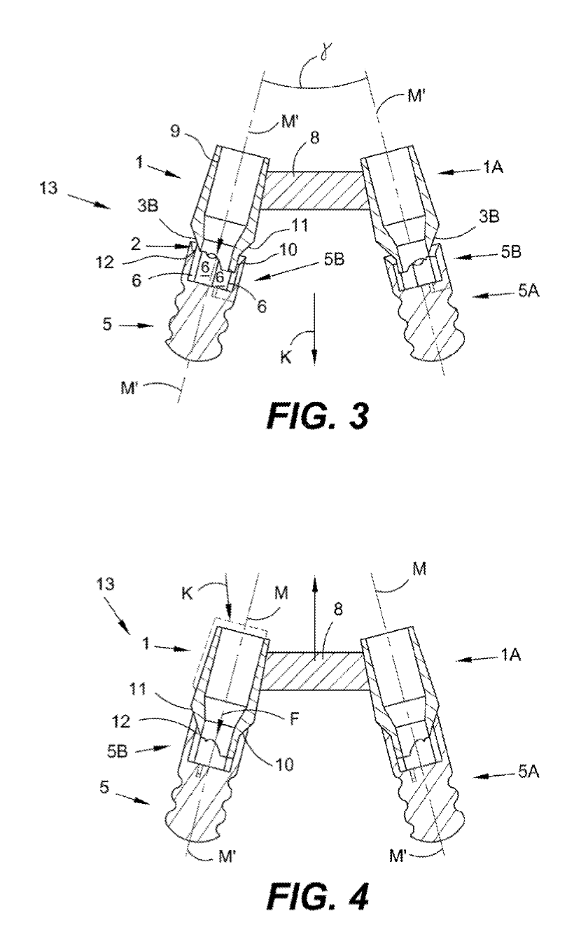

FIG. 3 shows a front view of two assemblies of an abutment and an implant in cross section, just before coupling;

FIG. 4 shows a front view of two assemblies of an abutment coupled with an implant in cross section;

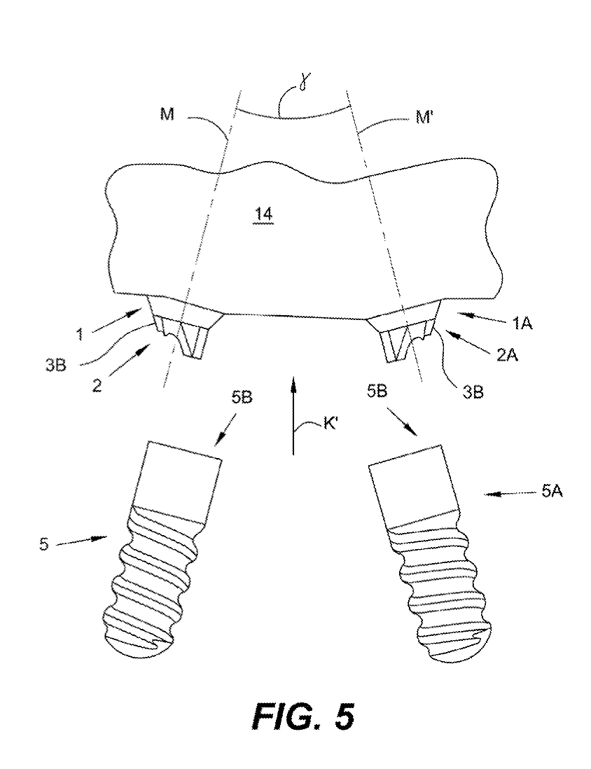

FIG. 5 shows a front view of two interconnected coupling devices with which an imprint is made;

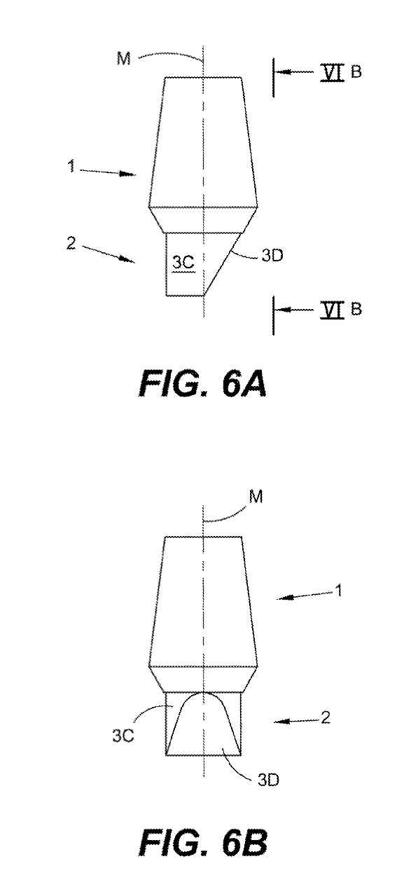

FIGS. 6A and 6B show a front and side elevational view of an abutment, respectively;

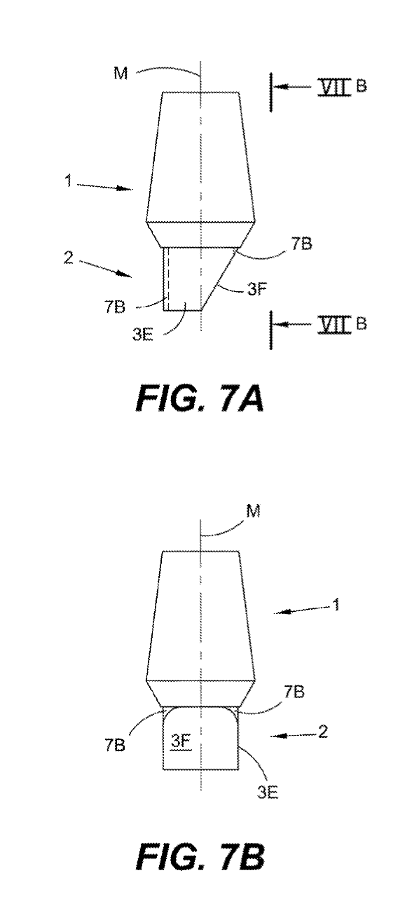

FIGS. 7A and 7B show a front and side elevational view of another abutment, respectively.

In this description, same or corresponding parts are designated by same or corresponding reference numerals. In the drawing, embodiments are only shown by way of example. The elements used therein are only mentioned by way of example and should not be construed as being limitative in any way. Other parts may also be used within the framework of the present invention.

FIGS. 1 and 2 show an abutment 1, which abutment 1 is provided with an octagonal coupling device 2. Through the center of the abutment 1, and through the coupling device 2, a first central axis M extends, in a longitudinal direction of the abutment 1. The coupling device 2 is provided with eight adjoining external coupling surfaces 3A, 3B extending about the first central axis M. The external coupling surfaces 3A, 3B are part of a projection which is used to couple the coupling device with a coupling part 5B. A circumference 4 which can be drawn around the coupling surfaces 3A, 3B, which circumference 4 extends in a plane perpendicular to above-mentioned first central axis M, forms an octagon. Such an abutment 1 is, for instance, called an octagonal abutment 1 in the field.

First surfaces 3A extend approximately parallel to the first central axis M, or at least at a relatively small, first angle α, while the first surfaces 3A taper somewhat in a coupling direction K of the abutment 1. This first angle α is, for instance, between about 0° and about 15°, preferably between 0° and 5°. In the example shown, the first angle α is about 3.25°. In the embodiment shown, the four first surfaces 3A, i.e. half of the coupling surfaces 3A, 3B of the coupling device 2, extend approximately parallel, or at the first angle α, with respect to the first central axis M. As shown, the first surfaces 3A are next to one another in abutment and are connected by means of surface boundaries 7A.

Opposite the first surfaces 3A, a series of adjoining, beveled, surfaces 3B extend. These beveled surfaces 3B extend at a particular second angle β with respect to the first central axis M, which angle β is larger than the above-mentioned relatively small first angle α of the first surfaces 3A. For instance, the second angle β of the beveled surfaces 3B is between about 5° and about 75°, in particular between about 10° and about 40°, and is, for instance, about 25°, so that the surfaces 3B taper relatively much in a coupling direction K of the abutment 1. For instance, the second angle β is at least 5°, in particular at least 10°, more in particular at least 20° larger than the first angle α, while the first angle α could be at 0°, for instance between 0° and 30°, preferably between 0° and 15°. The embodiment shown comprises four beveled surfaces 3B, half of the total number of surfaces 3A, 3B, while, preferably, the beveled surfaces 3B have been cleared, thereby forming the second angle β of about 25°.

In FIG. 3, an implant system is shown, where the coupling device 2 is arranged for coupling with a coupling part 5B, in this example part of an implant 5, more in particular a dental implant 5, thereby forming an assembly 13. In FIG. 3, two abutments 1, 1A are shown which are coupled in the coupling direction K with two corresponding implants 5, 5A. The abutments 1, 1A are then interconnected by means of a rigid connection, in particular a bridge 8. The rigid connection could also be formed by means of a different construction, for instance by means of a milled bar, crown or imprint (see FIG. 5).

A second central axis M′ extends through the center of the coupling part 5B of the implant 5, in particular in a longitudinal direction of the implant 5. In coupled condition (FIG. 4), the second central axis M′ of the implant 5 is preferably approximately at least partly in and/or in line with the first central axis M of the abutment 1. The coupling part 5B is provided with a bore with internal coupling surfaces 6, which extend approximately parallel to, or at least at a relatively small angle with respect to the second central axis M′. This relatively small angle may, for instance, be approximately equal to the above-mentioned first angle α and/or comprise, for instance, a particular tolerance angle. The circumference of the internal coupling surfaces 6 is preferably octagonal with sides of approximately equal sizes, the circumference extending in a plane perpendicular to the second central axis M′. In coupled condition, at least a part of the coupling surfaces 6 abut at least the external first surfaces 3A of the abutment 1. The dimensions and angles of the coupling surfaces 3A, 3B, 6 of the corresponding coupling parts 1, 5 are particularly arranged to prevent rotation of the abutment 1 about the first and/or second central axis M, M′. In addition, thereby, the orientation of the abutment 1 can be predetermined by positioning of the implants 5, 5B.

The abutment 1 may be provided with a bore 9 for feeding a fixing means through, such as for instance a screw or the like. For instance, the implant 5 is also provided with a bore, for instance for this fixing means. With such a fixing means, the abutment 1 can be coupled to the implant 5. As can be seen in FIG. 4, for instance by pushing or tightening the fixing means, an external support surface 11 of the abutment 1 is pressed against the implant 5, in particular against an internal receiving collar 10 of the implant 5, so that, in addition to rotation, movement of the abutment 1 out of the implant 5 can also be prevented.

In one embodiment, the receiving collar 10 of the implant 5, as well as the conical support surface 11 of the abutment 1, taper somewhat in coupling direction K. They both extend correspondingly obliquely, while the internal receiving collar 10 abuts to, and, at least in a coupled condition, extends at an approximately equal angle to, the external support surface 11 of the abutment 1. As a result, the coupling device 2 can be fed into the implant 5 relatively simply.

In coupled condition, the beveled surfaces 3B of the abutment 1 extend at a second angle β with respect to the first central axis M. The second angle β of the beveled surfaces 3B with the first central axis M is preferably larger than the angle of the corresponding, internal, surfaces 6 of the implant 5 with the second central axis M′, so that, in coupled condition, a space 12 can be left clear between the beveled surfaces 3B and the corresponding surfaces 6 of the implant 5. The angle of the internal surfaces 6 of the implant 5 is, for instance, about 0° or approximately equal to the above-mentioned first angle α of the first surfaces 3A so that the internal surfaces 6 and the external, first surfaces 3A abut one another in coupled condition.

An advantage of the beveled surfaces 3B is that the coupling device 2 can be placed in the implant 5 in a coupling direction K, while the coupling direction K does not need to be parallel to the first or second central axis M, M′ (see FIG. 4). The coupling device 2 may also be moved out of the implant 5 in a releasing direction K′, opposite to and parallel to coupling direction K, yet not parallel to one of the central axes M, M′. The coupling device 2 can be placed and/or removed in a direction K which is somewhat oblique with respect tot the central axis M′ of the implant 5, since, by the beveled surfaces 3B, space 12 is left clear and then no collision with the receiving collar 10 of the implant 5 needs to take place. An additional advantage may be that, upon placing two coupling devices 2 coupled with a rigid connection, the coupling devices 2 can simultaneously be placed into corresponding implants 5, 5A and/or can simultaneously be moved out of them, while it is not necessary that the implants 5, 5A, at least the coupling parts 5B, extend parallel with respect to one another, as appears from FIGS. 3 and 4. Because of this, the work with implant systems according to the invention needs less precision than conventional implant systems. For instance, two implants 5, 5A, at least the central axes M′ thereof, may be at an angle □ of at least 10°, in particular at least 40°, more in particular at least 70°, with respect to one another, while the two coupling devices 2 can be placed in the coupling parts 5B of the implants 5, 5A so as to block rotation, and can be released out of them, without adversely affecting the orientation of the implants 5, 5A. The maximum angle □ is, in principle, related to the second angle β of the beveled surfaces 3B. When the coupling device 2 is provided with beveled surfaces 3B with an angle β of about 25°, for instance, a clearance between the implant 5 and the abutment 1 can be achieved from and/or up to about 25° or 30°, depending on the small angle α which is, for instance, between 0° and 5°, and the maximum angle □ is, for instance, approximately between 50° and 60°. With two assemblies 13, the implants 5, 5A may, for instance, be at an angle □ with respect to one another of up to about 60°.

With a non-parallel position of the implants 5, 5A, the orientation of the beveled surfaces 3B may be chosen in a suitable manner. As can be seen in the example of FIG. 4, the implants 5, 5A lean inwards, while the beveled surfaces 3B are directed outwards. If the tops of the implants 5, 5A had leant more outwards, then the beveled surfaces would, for instance, have been directed more inwards.

In implant systems, use is often made of imprinting techniques, where, by means of an imprinting substance 14, a copy of the mouth situation can be obtained (see FIG. 5). In an imprinting situation, for instance, two or more implants 5, 5A are put in a jaw, after which the coupling devices 2 of the abutments 1, 1A are coupled with the coupling parts 5B of the implants 5, 5A, respectively. After this, the imprinting substance 14 is placed over the abutments 1, 1A, so that an imprint is formed of the abutments 1, 1A in the imprinting substance 14. The abutments 1, 1A are then interconnected by the imprinting substance 14. With the beveled surfaces 3B, at a particular angle □, it is possible to take the abutments 1, 1A with the imprinting substance 14 out of the implants 5, 5A, in a releasing direction K′ opposite and parallel to the coupling direction K, while the imprinting substance 14 does not or hardly deform. The imprinting substance 14 may, for instance, comprise a plastic. With conventional imprinting techniques, the implants 5, 5A need to be parallel to be able to obtain accurate imprints.

According to the same principle as coupling devices 2 and corresponding coupling parts 5B with an octagonal circumference 4, the coupling device 2 may, for instance, also be arranged with three, four, six or multiple angles, i.e. a polygon, while, for instance, half of the surfaces is beveled, thereby forming a clearance 12. Preferably, the coupling device 2 is provided with a part which abuts the coupling part 5B of a part that is clear from the coupling part 5B, so that release of the abutment 1 at a particular angle with the second central axis M′ can be achieved, through the clearance 12, while also positioning blocked in direction of rotation can be achieved, through the abutting parts of the coupling device 2 and the coupling part 5B. This may, for instance, also be achieved with different designs than polygons. For instance, the circumference of the coupling device 2 and/or the coupling part 5B may be in the shape of a clover and/or have at least partly rounded walls. Also with this, blocking of the rotation can be achieved, and also release of the abutment 1 at an angle with the second central axis M′ of the implant 5, or at least the coupling part 5B.

In an alternative embodiment, the coupling device 2 and/or the corresponding coupling part 5B is, in inner and outer circumference, respectively, for instance provided with a circumferentially continuous wall, of which a part, preferably half, is beveled. For instance, the wall 3C is cylindrical, of which a part 3D is beveled (see FIGS. 6A, 6B). The corresponding coupling part 5B may, for instance, be provided with a corresponding substantially cylindrical wall. Of course, the internal and external wall of the coupling part 5B and the coupling device 2, respectively, may have a small angle α with respect to the central axis M, so that the wall 3C may be somewhat conical. With this embodiment, it may, for instance, be possible to still rotate the abutment 1 about its center axis M in coupled condition. A second alternative embodiment is, for instance, shown in FIGS. 7A, 7B, where the coupling device 2 is provided with a circumferentially continuous wall 3E, while the circumference of the coupling device 2 has, for instance, the shape of a rectangle with rounded corners 7B. An inner wall of a corresponding coupling part 5B has a corresponding inner circumference. The coupling device 2 is provided with a beveled surface 3F. Preferably, about half of the wall 3E is beveled. In this embodiment, in coupled condition, rotation of the abutment 1 about its central axis M is blocked.

Instead of abutments 1, other devices may also be provided with coupling devices 2, for coupling with a coupling part 5B. Any device which needs to be fixed on an implant 5 may, in principle, be equipped with a coupling device 2 according to the invention. In addition to implants, also, intermediate pieces may be provided with coupling parts 5B, for instance for coupling between a coupling device 2 and an implant 5.

The above description concerns a coupling device 2 with external surfaces 3A, 3B for coupling with internal surfaces 6 of a coupling part 5B. In a different embodiment, the coupling device 2 is, for instance, provided with internal surfaces, while the coupling part may be provided with corresponding external surfaces.

The invention may also comprise a kit of separate parts, for instance a coupling device 2 and/or a coupling part 5B and/or a fixing means for coupling the coupling device 2 with the coupling part 5B, and/or a rigid connection for connecting two coupling devices 2, 2A and/or an imprinting device, which parts may, for instance, be part of an implant system. With such a kit, for instance, the assembly 13 may be obtained.

The variations described and many similar variations, as well as combinations thereof, are understood to fall within the framework of the invention described by the claims. Of course, different aspects of different embodiments and/or combinations thereof can be combined and exchanged within the framework of the invention. So, the invention should not be limited to only the above-mentioned embodiments.

1-18. (canceled)

19. A coupling device for an implant system, for coupling with a corresponding coupling part, wherein the coupling device is provided with at least one wall extending about a central axis, and at least a part of said at least one wall operatively abuts at least one corresponding wall of said corresponding coupling part so that operatively the coupling device and said coupling part are kept in position with respect to one another,
wherein a first part of said at least one wall extends approximately parallell, or at a first, relatively small angle, with respect to said central axis, and a second, beveled part of said at least one wall tapers relatively much with respect to said central axis, or at least extends at a second angle with respect to said central axis which is larger than said first angle, so that, upon coupling of the coupling device with said coupling pan, a relatively open space is provided between the second, beveled part and said corresponding coupling part.

20. A coupling device according to claim 19, wherein said at least one wall of the coupling device comprises adjoining surfaces extending about a central axis, wherein a circumference of the surfaces forms a polygon, and the circumference extends in a plane perpendicular to said central axis, and at least a part of said surfaces operatively abut corresponding surfaces of said corresponding coupling part so that, upon coupling of the coupling device with said coupling part, a mutual rotation about said central axis is prevented,
wherein first surfaces extend at least partly approximately parallel, or at least at a first, relatively small angle with respect to said central axis, and second, beveled surfaces taper relatively much with respect to said central axis, or extend at least at a second angle with respect to said central axis which is larger than said first angle, so that, upon coupling of the coupling device with said coupling part, a relatively open space is provided between the second, beveled surfaces and said corresponding coupling part.

21. A coupling device according to claim 19, wherein the second angle is between about 5° and about 70°, in particular between about 10° and about 40° larger than the first angle.

22. A coupling device according to claim 19, wherein said first angle is approximately smaller than or equal to 15°, preferably 5°.

23. A coupling device according to clam 20, 21, or 22, provided with at least three, preferably at least four surfaces, so that said circumference forms at least a triangle, preferably a quadrangle.

24. A coupling device according to claim 19, wherein about half of said at least one wall of the coupling device involves the second, beveled part.

25. A coupling, device according to claim 19, wherein about half of said at least one wall of the coupling, device involves said first part.

26. A coupling device according, to claim 19, which coupling device is part of an abutment.

27. A coupling device according to claim 19, wherein said at least one wall of the coupling device forms at least one external wall, and operatively at least partly abuts at least one corresponding internal wall of said coupling part.

28. An implant system provided with a coupling device according to claim 19 and said coupling part.

29. An implant system according to claim 28, wherein the coupling part has at least one internal wall which operatively abuts at least one external wall of the coupling device.

30. An implant system according to claim 28 or 29, wherein said coupling part comprises an implant.

31. An implant system according to claim 28, comprising at least two assemblies, wherein, with each assembly, the coupling device and the coupling part are coupled, wherein the at least one wall of the coupling device abuts a part of the at least one wall of said coupling part so that the coupling device and the coupling part assume a position with respect to one another, wherein the coupling device of a first assembly is at an angle with respect to the coupling device of a second assembly.

32. A method for coupling a coupling device with a coupling part in an implant system, wherein the coupling device, and the coupling part are each provided with at least one corresponding and operatively partly abutting wall, and wherein a part of the at least one wall of the coupling device is beveled with respect to the at least one corresponding wall of the coupling part, wherein the coupling device and the coupling part are partly fittingly slid into one another.

33. A method according to claim 32, wherein the circumference of said at least one wall of the coupling device and the coupling part, respectively, is arranged such that mutual rotation of the coupling device and the coupling part with respect to one another is prevented.

34. A method according to claim 32, wherein, after said sliding into one another, an open space remains between the beveled part of the coupling device and the corresponding wall part of the coupling part.

35. A method for coupling according to claim 32, wherein two interconnected coupling devices are each coupled with two corresponding, coupling parts, while the distance between the two connected coupling devices remains virtually equal, and, after coupling, the coupling devices are at an angle with respect to one another, in particular at an angle of more than 10°, more in particular more than 20°.

36. A method for coupling according to claim 32, 33, 34, or 35, wherein two coupled coupling devices are at an angle with respect to one another, in particular at an angle of more than 10°, more in particular more than 20°, and are intercoupled, and wherein the coupling devices are each slid out of the corresponding coupling parts, wherein, the distance between the coupling devices remains virtually equal and the arrangement and orientation of the coupling parts remains virtually equal.
